(19) United States
(12) Patent Application Publication
(10) Pub. No.: US 2024/0328777 A1
(43) Pub. Date: Oct. 3, 2024

(54) THZ MEASURING METHOD AND THZ MEASURING DEVICE FOR MEASURING A STRAND

(71) Applicant: CiTEX Holding GmbH, Melle (DE)

(72) Inventor: Ralph KLOSE, Melle (DE)

(21) Appl. No.: 18/620,057

(22) Filed: Mar. 28, 2024

(30) Foreign Application Priority Data
Mar. 31, 2023 (DE) 10 2023 108 274.4

(51) Int. Cl. G01B 11/06

(52) U.S. Cl. CPC G01B 11/06

(57) ABSTRACT

The present disclosure relates to a THz measuring method and a THz measuring device for measuring a profile, in particular, of an extruded pipe in a measuring space

### PRIORITY CLAIM

This application claims priority under to German Patent Application No. DE 10 2023 108 274.4, filed Mar. 31, 2023, which is expressly incorporated by reference herein.

### BACKGROUND

The present disclosure relates to a THz (terahertz) measuring method and a THz measuring device for measuring a strand in a measuring space.

### SUMMARY

According to the present disclosure, a THz measuring method and a THz measuring device allow for exact determination of the geometric characteristics of a strand, upon been extruded, with little effort.

In illustrative embodiments, a THz measuring method for measuring a transported strand, in a measuring space of a THz measuring device, including at least the following steps:
providing at least three THz measuring units around the measuring space, the THz measuring units each including a THz transceiver with an optical axis and a reflector arranged in the optical axis and situated opposite in the measuring space,
transporting the strand through the measuring space,
for all THz measuring units each
emitting a THz measuring beams from the THz transceiver along its optical axis and
detecting reflected THz radiation which has been partially reflected from the wall region facing the THz transceiver, and detecting THz radiation which has been reflected on the opposite reflector,

and for at least a first THz measuring unit
determining a facing wall thickness of the first optical axis by means of a first measuring signal of the first transceiver and
determining an averted wall thickness of the wall region averted from the transceiver on the first optical axis by means of the measuring signals of the THz transceivers of the adjacent THz measuring units that are adjacent in the circumferential direction to the first reflector.

In illustrative embodiments, a THz measuring device for measuring a strand, the THz measuring device comprising:
a measuring space with an axis of symmetry, for receiving the strand, at least three THz measuring units,
all THz measuring units each including a THz transceiver for emitting a THz measuring beams along its optical axis and a reflector arranged on the optical axis and opposite the THz transceiver,
a controller and evaluating unit receiving the measuring signals of the THz transceivers and determining at least wall thicknesses of the strand,
the THz measuring units being arrange in an alternating manner such that a first reflector of a first THz measuring unit is adjacent to a second THz transceiver of a second THz measuring unit and a third THz transceiver of a third THz measuring unit, the controller and evaluating unit being configured, in performing a measurement of the strand,
   to determine a facing wall thickness of the facing wall region from a first measuring signal of the first transceiver, and
   to determine an averted wall thickness of the averted wall region of the first transceiver by means of averaging and/or interpolation from measuring signals of the second transceiver and the third transceiver

The THz measuring device according to the present disclosure is able to perform, in particular, a THz measuring method according to the present disclosure. The THz measuring method according to the present disclosure can be performed, in particular, using the THz measuring device according to the present disclosure.

Thus, when determining the layer thickness or wall thickness respectively of the strand, always only the layer thickness of the wall region facing the THz transceiver is determined. To that end, in the measuring signal, in particular, the front or, respectively, first in time reflection peaks, and thus, in particular, the first and second reflection peak of the measuring signal, are used for calculating the layer thickness, in particular, as time-of-flight difference.

In contrast to comparative method and devices, the layer thickness of the respectively averted, rear wall region is not determined at each measuring position or, respectively, these values are not used for the determination despite the fact that the subsequent reflection peaks, i.e., in particular, the third and fourth reflection peak in a single layer pipe, are available in principle in the measuring signal.

The present disclosure is based in particular, on the finding that measurements of the averted wall region may often be impaired or compromised by various influencing factors. Thus, in particular, there may be a relevant misplacement of the strand the axis of symmetry of which usually lies—as explained above—not precisely on the axis of symmetry of the measuring space because, in particular, an extruded, still soft pipe will bend significantly upon transport. Even a minute misplacement in the measuring plane, in particular, in the averted wall region, leads to the beams partially reflected on the boundary surfaces not returning back to the transceiver due to their longer travel distance and the wider angular misplacement. It has become apparent, however, that the reflections on the boundary surfaces of the facing wall region, due to the significantly shorter travel distance as well as the smaller angular misplacement do return back to the transceiver to an extent sufficient to be evaluated as a signal.

Thus, the present disclosure, in particular, also allows for measuring using a THz measuring device without guide means; thus, in such a THz measuring device without guide means there is merely external guidance at points spaced farther apart, in particular, by virtue of the pulling-off device disposed further downstream which pulls of the strand in the transport direction, as well as at the extruder itself as well as, e.g., in a water bath spaced apart from the THz measuring device. Thus, the strand which is still soft and subject to mechanical tension and thermally caused shrinkage or warp, in particular, in the region of the THz measuring device is measured while hanging freely and may become maladjusted in the measuring plane. Configuring the THz measuring device without guide means creates certain further advantages. Thus, the THz measuring device is simpler and more cost-effective, further, it is easier to retrofit because additional guides may affect the production line as a whole. Also, there will be no additional mechanical load on the soft strand but the measuring will be completely contactless.

For larger misplacements of the strand an adjustment means may be provided to adjust the entire THz measuring device in the two dimensions of the measuring plane, e.g., by means of a cross table. Hereby, such an adjustment means allows for larger adjustments which cannot even be compensated by a guide means provided in the THz measuring device, furthermore, such an adjustment means can also be retrofitted easily and further allows contactless measuring of the strand.

The particular effect intended by the present disclosure that only facing wall regions are measured and this alone leads to a larger portion of the radiation partially reflected on the boundary surfaces returning back to the transceiver is further amplified, in particular, using parallel radiation instead of the comparative focusing onto the pipe axis. While parallel radiation, when the strand is centered precisely, has the disadvantage compared to the comparative focusing that a part of the radiation will not be reflected off the boundary surfaces along the measuring axis; this will be apparent, in particular, in the reflections on the boundary surfaces of the averted wall region. However, in particular, from the boundary surfaces of the facing wall region a sufficient portion is reflected back to the transceiver. Furthermore, in contrast to the focusing onto the—presumed—position of the pipe axis, a relevant portion is reflected back to the transceiver even in the case of misplacement of the strand because a part of the parallel radiation hits the round boundary surfaces at a more favorable angle. Thus, in particular, parallel radiation enhances the effect according to the present disclosure of measuring only the facing wall region.

A further advantage of measuring only facing wall regions, with subsequent averaging, lies in the signal strength of the detected radiation caused by less absorption inside the material. Thus, the measuring of the averted wall region may be impeded even by additives, e.g., soot as a common, radiation absorbing material. The THz measuring beam is partially absorbed and its intensity attenuated in the material of the facing wall region, and subsequently additionally in the averted wall region, and the partially reflected radiation is subsequently further attenuated upon passing through the facing wall region. Furthermore, the partial reflections on the facing boundary surfaces already cause attenuation of the intensity of the beam passing through; also, multiple reflections of the partially reflected beams on the boundary surfaces, i.e., repeated reflections of already reflected or partially reflected radiation, lead to signal attenuation and signal spread, which are relevant, in particular, in the temporally subsequent, averted reflection peaks of the averted wall region. Measuring only facing wall regions largely avoids these disadvantages.

Further, the material of the still soft strand may deviate from the ideal shape due sagging effects, i.e., a yield of, in particular, the interior surface. This causes problems, in particular, for measuring the averted wall region which may be positioned, even in the event of minute misplacement, such that the partial reflection peaks are not reflected back along the optical axis with sufficient precision. Generally, a misplacement of the strand or a boundary surface caused by sagging in relation to the axis of symmetry of the measuring space does not lead to the respective transceivers receiving no reflection signal of their facing, front wall region because the deflection in the lateral direction at small distances at smaller deflection angles will be small. Thus, while the measuring of the facing wall region will in general be sufficiently precise and secure even under conditions of slight misplacement and under absorption of the material, the measuring of the averted wall region will be significantly impaired by such influence variables. Thus, the subsequently reflected beams of the averted wall region, due to the longer path length through the interior space of the strand, will be subjected to a larger lateral offset to the optical axis and may possibly be undetectable by the transceiver.

According to the present disclosure, at least three THz measuring units are provided each including a THz transceiver and a reflector disposed opposite. The second and third THz measuring unit are arranged in a reverse orientation in relation to a middle first THz measuring unit, i.e., there is an arrangement of transceivers and reflectors alternating in the circumferential direction, the optical axes of the THz measuring units being offset against one another by an offset angle. Hereby, the averted wall region of the first THz measuring unit is measured as a calculation, in particular, averaging, of the measurements of the two adjacent THz measuring units, which each measure their facing wall region. Hereby, the averted wall thickness of the first THz measuring unit can be calculated by means of a direct arithmetic averaging of the determined facing wall thicknesses of the adjacent THz measuring units. Thus, a measurement can be conducted by merely using facing, front wall regions, where averted wall regions are calculated or averaged respectively by means of adjacent facing wall regions. Surprisingly, it is apparent that the averaging of adjacent measurements delivers better results than a direct measurement of the averted measuring region that is impaired by the aforementioned effects of misplacement as well as absorption and signal spread caused by multiple reflections.

Furthermore, in the alternating arrangement the reflectors of the adjacent measuring units may serve as screens for the transceiver lying in-between, e.g., leaving only a gap for the transceiver so that scatter radiation can be shielded off resulting in a further advantageous synergistic effect.

A layer thickness of the facing wall region is determined, in particular, from times of flight of the first reflection peak on the exterior surface and of the second reflection peaks on the interior surface of the facing wall region. In the case of multiple layer strands, accordingly more than two reflection peaks of the facing wall region of the THz transceiver may be determined, so as to determine multiple layer thicknesses of the strand accordingly.

In principle, the weaker subsequent, averted reflection peaks may be used for comparison to the values determined by averaging; however, as a rule, this is not required.

According to an advantageous embodiment, more than just three THz measuring units are arranged around the measuring space so that, for one thing, the offset angle between the reflectors and adjacent transceivers is small, thereby improving the accuracy of the averaging, and, for another, two adjacent THz measuring units are provided for each THz measuring unit so that for each THz measuring unit an averaging can be carried out using the adjacent THz measuring units. Thus, advantageously, all THz measuring units are equally valid and allow for a direct measuring of their facing, front wall region and indirect measuring using the adjacent THz measuring units.

Thus, in particular, in case of a dense arrangement, in principle, no additional technical expenditure is required compared to an arrangement using the direct measuring signals of the averted wall region.

Furthermore, the wall thickness of the averted wall region can be determined not only by the directly adjacent THz transceivers but also by the next but one THz transceivers or, respectively, a sequence of THz transceivers in the circumferential direction. This way, a higher degree of accuracy can be attained compared to an arithmetic averaging of only the two adjacent THz transceivers. Thus, the development of the wall thickness of the strand can be precisely monitored across wider regions as averaging, in particular, also as a reproduction in a model.

In principle, the measurements may be carried out simultaneously since, given a sufficiently narrow beam, the THz transceivers do not interfere with one another due to the angular offset. Further, the measurements may also be carried out alternating in time. In such an alternating activation the respectively passive transceivers may detect scatter radiation on imperfections or inclinations of the boundary surfaces in the event of, e.g., sagging, thereby allowing for an improved evaluation of inaccuracies. Moreover, beams may also be emitted in different frequency ranges and polarizations; however, using identical transceivers provides a particular advantage because this allows for a reduction in cost, because uniform THz measuring units are being used.

By carrying out measurements using the plurality of THz measuring units an incorrect position of the strand in relation to the axis of symmetry can be determined and used in evaluating the wall thicknesses so as to avoid deviation in the measuring signals to be falsely determined as poor quality of the strand despite the fact that there is merely a misplacement of the strand in relation to the axis of symmetry. Further, the determination of the incorrect position may also be used to correct the guiding of the strand.

Thus, the THz measuring device may also be configured, in particular, to be stationary, i.e., non-rotating or reversing, and yet allow for measuring the full circumference.

In principle, the THz measuring device may also rotate or reverse in the circumferential direction, e.g., when configured to include fewer measuring units.

The frequency range of the THz measuring beam may lie, in particular, in the frequency range between 5 GHZ and 50 THz, in particular, 10 GHZ and 10 THz, in particular, 20 GHz and 3 THz, preferably 50 GHz and 1 THz. Thus, the THz radiation may also extend into the range of radar radiation and/or microwave radiation. The THz measuring beam may be emitted and detected, in particular, as a direct time-of-flight measurement and/or using frequency modulation and/or as pulsed radiation. In particular, an FMCW radar allows for accurate measurement since the transceivers are cheap and compact in size making it possible to dispose a large number of THz measuring units.

Further, advantageously, in all embodiments a calibration measurement can be carried out. Thus, the present disclosure recognizes that the total reflection peak occurring in the THz measuring beam on the reflector lying behind the measuring space and thereby behind the strand will be sufficiently strong even under unfavorable conditions, in particular, also significantly stronger than the partial reflections on the boundary surfaces because the misplacement of the measured object does not or at least not to a relevant extent affect the total reflection peak and the signal of a total reflection is significantly stronger than the signals created by partial reflections. Thus, the total reflection peak can be used in the measuring even in the event of strong absorption. In particular, it is possible to first carry out a calibration measurement of the empty measuring space, i.e., in particular, prior to introducing the measured object, wherein the empty time of flight of the THz measuring beams from the respective transceivers to the reflectors and back is measured as total reflection peak. Hereby, in combination with the subsequent measurement of the time of flight with the included strand, a total delay can be determined which can be used together with the time-of-flight differences of the boundary surfaces to determine both the refractive index and layer thicknesses, in particular, additionally also geometric properties like exterior diameter and interior diameter. The averaging of the averted wall region sidesteps the problem of the reflector preventing a transceiver from being positioned directly in front of this wall region. Thus, according to the present disclosure, the calibration measurement with a reflector can be combined with measuring only facing wall regions. The measuring of the total reflection peak with the included strand can be carried out together with the measuring of the partial reflection peak, or even successively in discrete measuring steps.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a THz measuring device according to an embodiment for measuring at least one measuring axis comprising three measuring units;

FIG. 2 shows a THz measuring device comprising nine measuring units consisting of transceiver and mirror, for measuring in nine measuring axes;

FIG. 3 shows a further embodiment with plane mirrors;

FIG. 3a shows a section from FIG. 3; and

FIG. 4 a signal diagram in evaluation of a THz measuring signal.

### DETAILED DESCRIPTION

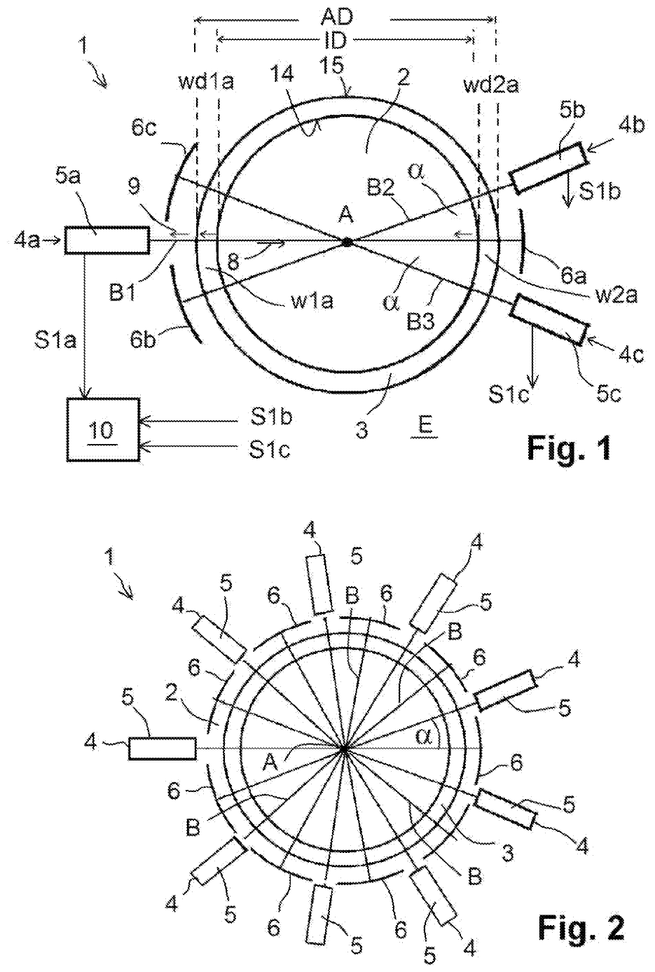

According to FIGS. 1 and 2 a THz measuring device 1 comprises a measuring space 2 through which a strand, in this case an extruded pipe 3, is continuously transported along an axis of symmetry A and measured. Hereby, in particular, no guide means is provided, but the pipe 3 discharged from an extruder is e.g., pulled off by a pull-off device at a point downstream in the transport direction and passes freely through the measuring space 2 between the extruder and the downstream point so that the pipe 2 which is still soft and subject to mechanical tension and thermal shrinkage or warping may become misadjusted, in particular, also in the measuring plane, thereby, generally, not being guided exactly along the axis of symmetry A.

The THz measuring device 1 comprises multiple THz measuring units 4; according to FIG. 1, three THz measuring units 4a, 4b, 4c are provided, each made up of a THz transceiver 5 and a reflector 6 and, as shown here, arranged around the measuring space 2 distributed in the circumferential direction. Each THz transceiver 5, 5a, 5b, 5c is provided at a measuring position MP1, MP2, MP3, and the respective reflector 6, 6a, 6b, 6c at a reflector position RP1, RP2, RP3.

Hereby, a second measuring unit 4b and a third measuring unit 4c are deposed staggered opposite the first measuring unit 4a. Thus, in the embodiment of FIG. 1 involving the three THz measuring devices 4a, 4b and 4c, the first THz measuring unit 4a is formed by the first THz transceiver 5a, defining a first optical axis B1, and the first reflector 6a arranged opposite on the first optical axis B1, and accordingly in the case of the other THz measuring units 4b, 4c. The optical axes B1, B2, B3 of the three THz measuring units 4a, 4b, 4c lie in the common measuring plane E and intersect in the axis of symmetry A. The second THz transceiver 5b and the third THz transceiver 5c lie adjacent the first reflector 6a, the second optical axis B2 and the third optical axis B3 being offset against the first optical axis B1 each by an offset angle α so that the first optical axis B1 extends centrally between the optical axes B2 and B3. Hereby, the offset angle α is sufficiently small to carry out the averaging described below. Thus, the reflector positions RP1, RP2, RP3 of the reflectors 6a, 6b, 6c lie on the circumference of the measuring space 2 or, respectively, the measuring apparatus 1 always between the two measuring positions MP1, MP2, MP3 of the two adjacent THz transceivers 5a, 5b, 5c. Preferably, the THz measuring units 4a, 4b, 4c are arranged statically around the measuring space 2, i.e., preferably, not rotating or reversing. The THz measuring units 4a, 4b, 4c put out measuring signals S1a, S1b, S1c to a controller and evaluation unit 10 which carries out a determination.

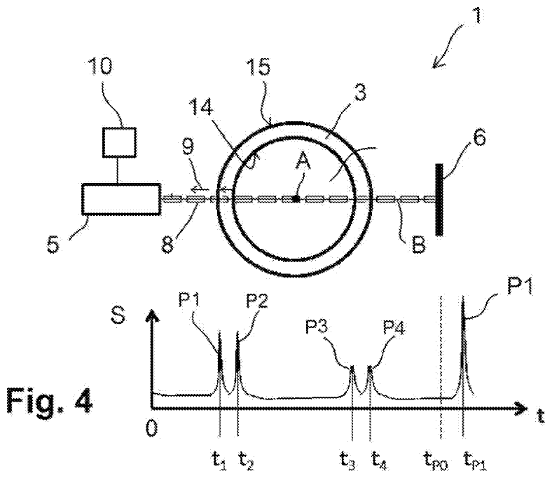

Initially, prior to inserting the pipe 3, a calibration measurement is carried out in which the shown THz measuring device 1 performs a measurement with empty measuring space 2, i.e., without a strand or pipe 3 respectively, which is to be used as calibration measurement for the subsequent determination of both wall thicknesses and refractive index. Thereafter, the pipe 3 is continuously guided along the axis of symmetry A through the measuring space 2 and measured. Hereby, the THz transceiver 5a emits a THz beam 8 along its optical axis B1 which first passes through a facing wall region w1a of the pipe 3, then through the interior of the pipe 3 on its way to the averted wall region w1b of the pipe 3, and subsequently reaches the first reflector 6a which reflects the first THz beam 8a along the first optical axis B1 back to the first THz transceiver 5a. The first THz beam 8a is partially reflected each on the boundary surfaces of the facing wall region w1a and of the averted wall region w2a, hereby reflecting reflected THz radiation 9 that reaches the THz transceiver 5a along the optical axis B1. Thus, hereby, the THz radiation 9 reflected on an exterior surface 15 and an interior surface 14 of the pipe 3 is detected by the first transceiver 5a. Thus, the THz transceiver 5a receives a measuring signal shown in FIG. 4 which exhibits a first reflection peak P1 on the exterior surface 15 in the facing wall region w1a, a second reflection peak P2 on the interior surface 14 of the facing wall region w1a, then, having passed the interior of the pipe, corresponding reflection peaks P3 and P4 in the averted wall region w2a of the pipe 3, and the total reflection peak TP on the first reflector 6a, at the indicated points in time t1, t2, t3, t4 and tP1. Accordingly, in the calibration measurement merely the total reflection peak TP at time tP0 is measured; in the subsequent object measurement the total reflection peak TP is delayed to be at a slightly later time tP1. Thus, comparing the measurements allows both the geometric properties of the pipe 3 along the first optical axis B1, i.e., in particular, exterior diameter AD, interior diameter ID, and wall thicknesses wd1, wd2, and the refractive index n3 of the pipe 3 to be determined.

The advantage of the present disclosure is recognized as the fact that in determining the averted wall thickness wd2a of the averted wall region w2a the third and fourth reflection peak P3 and P4 of the averted wall region w2a are not used, but a determination is made by averaging of the measurements of the adjacent THz measuring units 4b, 4c. In certain pipes 3 or strands respectively the later-in-time averted reflection peaks P3 and P4 are significantly weaker and widened, caused, in particular, by the attenuation of the THz radiation in the pipe material as well as misplacements of the pipe 3 in relation to the axis of symmetry A. To generate the temporally successive reflection peaks P3 and P4 the THz measuring beam 8 and the reflected radiation 9 pass through several boundary surfaces and a larger material width, whereby, generally, the pipe material may also have attenuating, i.e., energy absorbing characteristics depending, in particular, also upon additives like, e.g., soot or graphite which may be added to the pipe materials in various concentrations. Furthermore, misplacements and geometrical errors of the pipe also lead to deviations in the beam path compared to the ideal optical axis B1 which may have a stronger effect on the temporally successive reflection peaks P3 and P4.

As shown above, in the adjacent measuring units 4b and 4c the transceivers 5b and 5c are arranged adjacent to the first reflector 6a, i.e., in alternating arrangement of the transceiver 5 and the reflector 6. The second measuring unit 4b and third measuring unit 4c carry out measurements corresponding to those of the first THz measuring unit 4a, i.e., the calibration measurement with empty measuring space 2, and subsequent object measurement with the pipe 3 included. Hereby, again, at least the reflection peaks P1 and P2 of the THz measuring beam 5b along the optical axis B2, i.e., the partial reflections on the exterior surface 13 and interior surface 14 of the pipe 3, are used, and, accordingly, the first measuring peak P1 and the second measuring peak P2 of the third THz measuring unit 4c along the third optical axis B3. Further, the total reflection peaks TP of the second and third measurements are used.

Thereafter, the averted wall thickness wd2a is determined by averaging the measurements of the THz measuring units 4b and 4c. Hereby, the wall thickness wd2 is calculated along the first optical axis B1 from an averaging of the wall thicknesses wd1 of the respective facing wall region along the second optical axis B2 and the third optical axis B3. Such averaging may be performed, in particular, by direct arithmetic averaging, i.e., one half of the sum of the determined wall thicknesses along the optical axis B1 and B2. Furthermore, averaging across several transceivers and calculations of wall paths are possible also, as will be described further below.

Thus, the strong measuring peaks P1 and P2 of the respective facing wall region w1a of each THz measuring unit 4a, 4b and 4c may be used to determine both wall thicknesses w1a and w2a as well as of the further geometric properties of the pipe 3, i.e., exterior diameter AD and interior diameter ID.

In principle, it is possible to compare the averted wall thicknesses wd2 determined by averaging with the measurements of the measuring peaks P3 and P4; however, as a rule, this is not required.

In the embodiment according to FIG. 2, accordingly, nine THz measuring units 4 are arranged in the circumferential direction around the measuring space 2 and thereby around the pipe 3 contained therein, i.e., symmetrically to the axis of symmetry A, e.g., each at equal offset angles alpha in relation to one another. Thus, their optical axes B intersect in the axis of symmetry A. This results in an arrangement of THz transceivers 5 and reflectors 6 alternating in the circumferential direction. Hereby, each THz transceiver 5 may first conduct a measurement of its facing wall region w1a as first THz transceiver 5a according to FIG. 1, and its respectively averted wall region w2a may be determined by averaging by the opposite, adjacent THz measuring units. Thus, the symmetrical and narrow arrangement allows a determination to be made with a high degree of precision for each THz transceiver 5 from the respective adjacent THz measuring unit 4 so that the arrangement made up of nine THz measuring units 4 shown here allows for a measuring of the full perimeter of the pipe 3 along the nine measuring axes B shown. Thus, in installation with larger diameters, e.g., 15 to 23, in particular, 19 measuring units 4 may be provided in an alternating manner.

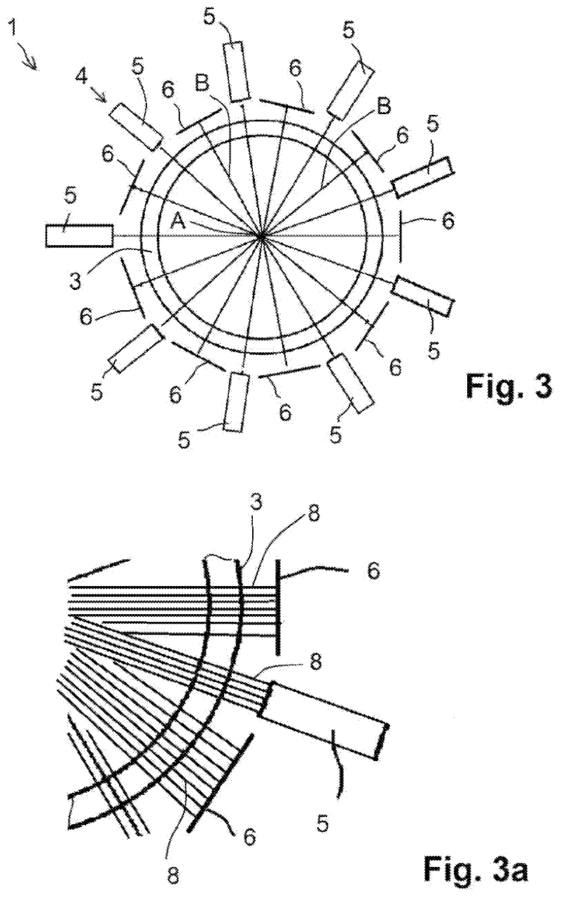

In the embodiment according to FIG. 3, the reflectors 6 are configured to be flat instead of the convex configuration shown in FIGS. 1 and 2. Here, advantageously, THz measuring beams 8 are used which are emitted in parallel, bearing the advantage compared to focused THz measuring beams 8 that the times of flight of the beam areas are equal. In a comparative focusing or concentration respectively of the THz measuring beams 8 by means of the optics of the THz transceivers 5, as it is done in part of the initially mentioned comparison, the travel paths for outer areas of the bundle of rays will be longer than for inner areas so that the measuring signal will be negatively affected, e.g., widened. It is apparent, in particular, that in the above-described measuring of the facing wall regions w1a a bundling is not as helpful as in comparative measuring, where the concentration or focusing respectively is intended to increase the intensity and thereby the signal strength of the weaker reflection peaks.

Thus, a parallel beam guidance according to FIG. 3 collaborates in a particular manner with the above-described use of only the facing reflection peaks P1 and P, as well as the total reflection peaks TP.

In principle, the THz transceivers 5 may operate inside the same frequency range because they do not affect. Thus, equal THz transceivers 5 can be used, in particular, even in an arrangement which narrow in relation to one another, because the scatter radiation in measuring the facing wall regions w1a is not so relevant and the determination of the averted wall thickness is improved. Thus, according to the present disclosure, by virtue of the narrow arrangement, in particular, even a static arrangement of the THz measuring units 4 may be provided, because the dense arrangement allows for measuring largely the full circumference.

Furthermore, it is also possible to provide a separation by means of, e.g., different polarizations of the THz-beams.

Advantageously, the opposing reflectors 6 may till serves as deflector for the THz transceivers 5 disposed in-between them, as can be seen in FIGS. 2 and 3. Hereby, the gaps between the reflectors 6 may be kept sufficiently small so as to pass merely optical radiation along the optical axes B so that the deflectors are formed by the reflectors.

In calculating the averted wall thickness wd2a of a measured unit 4a measuring signals of the subsequent adjacent THz transceiver 4 may be included also, in addition to the measuring signals of the immediately adjacent measured units 4b and 4c, as shown in FIG. 1, and this is valid also, in particular, for embodiments with a large number and therewith high density of THz measuring units 4. Thus, the determination of the averted wall thickness wd2a or each THz measuring unit 4 may be carried out as averaging across several THz measuring units, in particular, determined as a wall thickness profile.

Thus, it is also possible to determine a circumferential surface area progression of the surfaces 14 and 15.

A comparative THz measuring device of this type and a corresponding measuring method include a plurality of THz transceivers are arranged in a common plane around a measuring space, and they send their THz measuring beam or THz transmission beam respectively along their optical axis towards an axis of symmetry so that the incident THz radiation will be partially reflected on boundary surfaces of the walls of the measured object and the THz transceiver picks up corresponding partial reflection peaks so that wall thicknesses and further geometric properties of the measured object can be determined directly or indirectly from the times of flight.

A comparative THz measuring device in which THz radiation of a THz transceiver put out by the THz transceiver is linear focused, where it is focused in the measuring plane onto the axis of symmetry and aligned in parallel along the axis of symmetry. For measuring a strand is guided through the measuring apparatus by means of a guide means of the measuring device. The guide means allows for a centering of the strand so that the boundary surfaces of the two wall regions of the strand lies exactly perpendicular to the optical axis of the THz measuring beam. The measuring beam creates partial reflection peaks each on the two boundary surfaces of the facing wall region and the two boundary surfaces of the averted wall region, and from the times of flight of these the wall thicknesses are determined.

A comparative measuring apparatus of this type including a guide means allows the strand to be centered in the measuring apparatus so that the four boundary surfaces are aligned perpendicular to the optical axis of the measuring beam. Upon extrusion the strand will still be hot and soft or pasty respectively so that it will continuously dissemble dues to gravity and mechanical tensions including, in particular, thermal tensions. However, even small displacements lead to at least one of the boundary surfaces being aligned no longer sufficiently orthogonal to the measuring axis so that measuring is no longer possible. The further guides of the strand in the production line, i.e., outside the measuring apparatus, by virtue of a downstream pull-off device and e.g., at a water bath, alone do not guarantee sufficiently precise positioning of the strand in the measuring apparatus, because here there will be distances of several meters and the soft, hot strand may sag significantly even in the case of free distances of less than one meter so that the exact positioning and centering is secured by the guide means of the comparative THz measuring device. Thus, it is also possible, in particular, to provide that the boundary surfaces of the averted wall region are reflected back to the detector.

Such a comparative guide of the strand by means of the measuring apparatus however, is relatively complex, also because the hot, soft strand is hard to guide. Moreover, this additional guide may result in tensions in the strand; in principle, it is of advantage to refrain from unnecessarily stressing the soft, still curing strand, i.e., to allow the strand to cool unguided across a wider length, and to tolerate maladjustment of the strand upon curing. Also, the guide means which needs to be additionally provided complicates retrofitting of an existing extrusion line with the THz measuring device. The particular advantage of THz measuring devices lies in the fact that measurements can be taken contactless; this will be prevented ultimately by the guide means.

Furthermore, it is apparent that in this measuring apparatus the precision of the determined geometric values, in particular, of the wall thicknesses, is affected for certain measured objects. Thus, measurements of plastic pipes may lead to differing measuring accuracies depending of the materials used, e.g., including the additives.

The present disclosure is based on the object of creating a THz measuring method and a THz measuring device allowing for exact determination of the geometric characteristics of a strand, upon been extruded, with little effort.

This task is solved by a THz measuring method as well as a THz measuring device according to the independent claims. Preferred further developments are described in the sub-claims.

Thus, there is provided a THz measuring method for measuring a transported strand, in a measuring space of a THz measuring device, including at least the following steps:
providing at least three THz measuring units around the measuring space, the THz measuring units each including a THz transceiver with an optical axis and a reflector arranged in the optical axis and situated opposite in the measuring space,
transporting the strand through the measuring space,
for all THz measuring units each
emitting a THz measuring beams from the THz transceiver along its optical axis and
detecting reflected THz radiation which has been partially reflected from the wall region facing the THz transceiver, and detecting THz radiation which has been reflected on the opposite reflector, and

for at least a first THz measuring unit
determining a facing wall thickness of the first optical axis by means of a first measuring signal of the first transceiver and
determining an averted wall thickness of the wall region averted from the transceiver on the first optical axis by means of the measuring signals of the THz transceivers of the adjacent THz measuring units that are adjacent in the circumferential direction to the first reflector.

Further, there is provided a THz measuring device for measuring a strand, the THz measuring device comprising:
a measuring space with an axis of symmetry, for receiving the strand, at least three THz measuring units,
all THz measuring units each including a THz transceiver for emitting a THz measuring beams along its optical axis and a reflector arranged on the optical axis and opposite the THz transceiver,
a controller and evaluating unit receiving the measuring signals of the THz transceivers and determining at least wall thicknesses of the strand,
the THz measuring units being arrange in an alternating manner such that a first reflector of a first THz measuring unit is adjacent to a second THz transceiver of a second THz measuring unit and a third THz transceiver of a third THz measuring unit, the controller and evaluating unit being configured, in performing a measurement of the strand,
   to determine a facing wall thickness of the facing wall region from a first measuring signal of the first transceiver, and
   to determine an averted wall thickness of the averted wall region of the first transceiver by means of averaging and/or interpolation from measuring signals of the second transceiver and the third transceiver.

The THz measuring device according to the present disclosure is able to perform, in particular, a THz measuring method according to the present disclosure. The THz measuring method according to the present disclosure can be performed, in particular, using the THz measuring device according to the present disclosure.

Thus, when determining the layer thickness or wall thickness respectively of the strand, always only the layer thickness of the wall region facing the THz transceiver is determined. To that end, in the measuring signal, in particular, the front or, respectively, first in time reflection peaks, and thus, in particular, the first and second reflection peak of the measuring signal, are used for calculating the layer thickness, in particular, as time-of-flight difference.

In contrast—differing from the comparatives—the layer thickness of the respectively averted, rear wall region is not determined at each measuring position or, respectively, these values are not used for the determination despite the fact that the subsequent reflection peaks, i.e., in particular, the third and fourth reflection peak in a single layer pipe, are available in principle in the measuring signal.

The present disclosure is based in particular, on the finding that measurements of the averted wall region may often be impaired or compromised by various influencing factors. Thus, in particular, there may be a relevant misplacement of the strand the axis of symmetry of which usually lies—as explained above—not precisely on the axis of symmetry of the measuring space because, in particular, an extruded, still soft pipe will bend significantly upon transport. Even a minute misplacement in the measuring plane, in particular, in the averted wall region, leads to the beams partially reflected on the boundary surfaces not returning back to the transceiver due to their longer travel distance and the wider angular misplacement. It has become apparent, however, that the reflections on the boundary surfaces of the facing wall region, due to the significantly shorter travel distance as well as the smaller angular misplacement do return back to the transceiver to an extent sufficient to be evaluated as a signal.

Thus, the present disclosure, in particular, also allows for measuring using a THz measuring device without guide means; thus, in such a THz measuring device without guide means there is merely external guidance at points spaced farther apart, in particular, by virtue of the pulling-off device disposed further downstream which pulls of the strand in the transport direction, as well as at the extruder itself as well as, e.g., in a water bath spaced apart from the THz measuring device. Thus, the strand which is still soft and subject to mechanical tension and thermally caused shrinkage or warp, in particular, in the region of the THz measuring device is measured while hanging freely and may become maladjusted in the measuring plane. Configuring the THz measuring device without guide means creates certain further advantages. Thus, the THz measuring device is simpler and more cost-effective, further, it is easier to retrofit because additional guides may affect the production line as a whole. Also, there will be no additional mechanical load on the soft strand but the measuring will be completely contactless.

For larger misplacements of the strand an adjustment means may be provided to adjust the entire THz measuring device in the two dimensions of the measuring plane, e.g., by means of a cross table. Hereby, such an adjustment means allows for larger adjustments which cannot even be compensated by a guide means provided in the THz measuring device, furthermore, such an adjustment means can also be retrofitted easily and further allows contactless measuring of the strand.

The particular effect intended by the present disclosure that only facing wall regions are measured and this alone leads to a larger portion of the radiation partially reflected on the boundary surfaces returning back to the transceiver is further amplified, in particular, using parallel radiation instead of the comparative focusing onto the pipe axis. While parallel radiation, when the strand is centered precisely, has the disadvantage compared to the comparative focusing that a part of the radiation will not be reflected off the boundary surfaces along the measuring axis; this will be apparent, in particular, in the reflections on the boundary surfaces of the averted wall region. However, in particular, from the boundary surfaces of the facing wall region a sufficient portion is reflected back to the transceiver. Furthermore, in contrast to the focusing onto the—presumed—position of the pipe axis, a relevant portion is reflected back to the transceiver even in the case of misplacement of the strand because a part of the parallel radiation hits the round boundary surfaces at a more favorable angle. Thus, in particular, parallel radiation enhances the effect according to the present disclosure of measuring only the facing wall region.

A further advantage of measuring only facing wall regions, with subsequent averaging, lies in the signal strength of the detected radiation caused by less absorption inside the material. Thus, the measuring of the averted wall region may be impeded even by additives, e.g., soot as a common, radiation absorbing material. The THz measuring beam is partially absorbed and its intensity attenuated in the material of the facing wall region, and subsequently additionally in the averted wall region, and the partially reflected radiation is subsequently further attenuated upon passing through the facing wall region. Furthermore, the partial reflections on the facing boundary surfaces already cause attenuation of the intensity of the beam passing through; also, multiple reflections of the partially reflected beams on the boundary surfaces, i.e., repeated reflections of already reflected or partially reflected radiation, lead to signal attenuation and signal spread, which are relevant, in particular, in the temporally subsequent, averted reflection peaks of the averted wall region. Measuring only facing wall regions largely avoids these disadvantages.

Further, the material of the still soft strand may deviate from the ideal shape due sagging effects, i.e., a yield of, in particular, the interior surface. This causes problems, in particular, for measuring the averted wall region which may be positioned, even in the event of minute misplacement, such that the partial reflection peaks are not reflected back along the optical axis with sufficient precision. Generally, a misplacement of the strand or a boundary surface caused by sagging in relation to the axis of symmetry of the measuring space does not lead to the respective transceivers receiving no reflection signal of their facing, front wall region because the deflection in the lateral direction at small distances at smaller deflection angles will be small. Thus, while the measuring of the facing wall region will in general be sufficiently precise and secure even under conditions of slight misplacement and under absorption of the material, the measuring of the averted wall region will be significantly impaired by such influence variables. Thus, the subsequently reflected beams of the averted wall region, due to the longer path length through the interior space of the strand, will be subjected to a larger lateral offset to the optical axis and may possibly be undetectable by the transceiver.

According to the present disclosure, at least three THz measuring units are provided each including a THz transceiver and a reflector disposed opposite. The second and third THz measuring unit are arranged in a reverse orientation in relation to a middle first THz measuring unit, i.e., there is an arrangement of transceivers and reflectors alternating in the circumferential direction, the optical axes of the THz measuring units being offset against one another by an offset angle. Hereby, the averted wall region of the first THz measuring unit is measured as a calculation, in particular, averaging, of the measurements of the two adjacent THz measuring units, which each measure their facing wall region. Hereby, the averted wall thickness of the first THz measuring unit can be calculated by means of a direct arithmetic averaging of the determined facing wall thicknesses of the adjacent THz measuring units. Thus, a measurement can be conducted by merely using facing, front wall regions, where averted wall regions are calculated or averaged respectively by means of adjacent facing wall regions. Surprisingly, it is apparent that the averaging of adjacent measurements delivers better results than a direct measurement of the averted measuring region that is impaired by the aforementioned effects of misplacement as well as absorption and signal spread caused by multiple reflections.

Furthermore, in the alternating arrangement the reflectors of the adjacent measuring units may serve as screens for the transceiver lying in-between, e.g., leaving only a gap for the transceiver so that scatter radiation can be shielded off resulting in a further advantageous synergistic effect.

A layer thickness of the facing wall region is determined, in particular, from times of flight of the first reflection peak on the exterior surface and of the second reflection peaks on the interior surface of the facing wall region. In the case of multiple layer strands, accordingly more than two reflection peaks of the facing wall region of the THz transceiver may be determined, so as to determine multiple layer thicknesses of the strand accordingly.

In principle, the weaker subsequent, averted reflection peaks may be used for comparison to the values determined by averaging; however, as a rule, this is not required.

According to an advantageous embodiment, more than just three THz measuring units are arranged around the measuring space so that, for one thing, the offset angle between the reflectors and adjacent transceivers is small, thereby improving the accuracy of the averaging, and, for another, two adjacent THz measuring units are provided for each THz measuring unit so that for each THz measuring unit an averaging can be carried out using the adjacent THz measuring units. Thus, advantageously, all THz measuring units are equally valid and allow for a direct measuring of their facing, front wall region and indirect measuring using the adjacent THz measuring units.

Thus, in particular, in case of a dense arrangement, in principle, no additional technical expenditure is required compared to an arrangement using the direct measuring signals of the averted wall region.

Furthermore, the wall thickness of the averted wall region can be determined not only by the directly adjacent THz transceivers but also by the next but one THz transceivers or, respectively, a sequence of THz transceivers in the circumferential direction. This way, a higher degree of accuracy can be attained compared to an arithmetic averaging of only the two adjacent THz transceivers. Thus, the development of the wall thickness of the strand can be precisely monitored across wider regions as averaging, in particular, also as a reproduction in a model.

In principle, the measurements may be carried out simultaneously since, given a sufficiently narrow beam, the THz transceivers do not interfere with one another due to the angular offset. Further, the measurements may also be carried out alternating in time. In such an alternating activation the respectively passive transceivers may detect scatter radiation on imperfections or inclinations of the boundary surfaces in the event of, e.g., sagging, thereby allowing for an improved evaluation of inaccuracies. Moreover, beams may also be emitted in different frequency ranges and polarizations; however, using identical transceivers provides a particular advantage because this allows for a reduction in cost, because uniform THz measuring units are being used.

By carrying out measurements using the plurality of THz measuring units an incorrect position of the strand in relation to the axis of symmetry can be determined and used in evaluating the wall thicknesses so as to avoid deviation in the measuring signals to be falsely determined as poor quality of the strand despite the fact that there is merely a misplacement of the strand in relation to the axis of symmetry. Further, the determination of the incorrect position may also be used to correct the guiding of the strand.

Thus, the THz measuring device may also be configured, in particular, to be stationary, i.e., non-rotating or reversing, and yet allow for measuring the full circumference.

In principle, the THz measuring device may also rotate or reverse in the circumferential direction, e.g., when configured to include fewer measuring units.

The frequency range of the THz measuring beam may lie, in particular, in the frequency range between 5 GHZ and 50 THz, in particular, 10 GHZ and 10 THz, in particular, 20 GHz and 3 THz, preferably 50 GHz and 1 THz. Thus, the THz radiation may also extend into the range of radar radiation and/or microwave radiation. The THz measuring beam may be emitted and detected, in particular, as a direct time-of-flight measurement and/or using frequency modulation and/or as pulsed radiation. In particular, an FMCW radar allows for accurate measurement since the transceivers are cheap and compact in size making it possible to dispose a large number of THz measuring units.

Further, advantageously, in all embodiments a calibration measurement can be carried out. Thus, the present disclosure recognizes that the total reflection peak occurring in the THz measuring beam on the reflector lying behind the measuring space and thereby behind the strand will be sufficiently strong even under unfavorable conditions, in particular, also significantly stronger than the partial reflections on the boundary surfaces because the misplacement of the measured object does not or at least not to a relevant extent affect the total reflection peak and the signal of a total reflection is significantly stronger than the signals created by partial reflections. Thus, the total reflection peak can be used in the measuring even in the event of strong absorption. In particular, it is possible to first carry out a calibration measurement of the empty measuring space, i.e., in particular, prior to introducing the measured object, wherein the empty time of flight of the THz measuring beams from the respective transceivers to the reflectors and back is measured as total reflection peak. Hereby, in combination with the subsequent measurement of the time of flight with the included strand, a total delay can be determined which can be used together with the time-of-flight differences of the boundary surfaces to determine both the refractive index and layer thicknesses, in particular, additionally also geometric properties like exterior diameter and interior diameter. The averaging of the averted wall region sidesteps the problem of the reflector preventing a transceiver from being positioned directly in front of this wall region. Thus, according to the present disclosure, the calibration measurement with a reflector can be combined with measuring only facing wall regions. The measuring of the total reflection peak with the included strand can be carried out together with the measuring of the partial reflection peak, or even successively in discrete measuring steps.

The present disclosure relates to a THz measuring method and a THz measuring device for measuring a profile (3), in particular, of an extruded pipe (3) in a measuring space (2), including at least the following steps:
providing at least three THz measuring units (4) around the measuring space (2), the THz measuring units (4) each including a THz transceiver (5, 5a, 5b, 5c) with an optical axis (B) and a reflector (6; 6a, 6b, 6c) arranged in the optical axis (B) and situated opposite in the measuring space (2),
transporting the strand (3) through the measuring space (2),
for all THz measuring units (4, 4a, 4b, 4) each
emitting a THz measuring beams (8) from the THz transceiver (5) along its optical axis (B) and
detecting reflected THz radiation (9) which has been partially reflected from the wall region facing the THz transceiver (5), and detecting THz radiation (9) which has been reflected on the opposite reflector (6),

and for at least a first THz measuring unit (4a)
determining a facing wall thickness (wd1a) of the first optical axis (B1) by means of a first measuring signal of the first transceiver (5a) and
determining an averted wall thickness (wd2a) of the wall region averted from the transceiver (Sa) on the first optical axis (B1) by means of the measuring signals (S1b, S1c) of the THz transceivers (5b, 5c) of the adjacent THz measuring units (4b, 4c) that are adjacent in the circumferential direction to the first reflector (6a).

### LIST OF REFERENCE NUMERALS

1 THz measuring device
2 measuring space
3 strand, in particular, pipe
4 THz measuring unit
4a, 4b, 4c first to third THz measuring unit
5 THz transceiver
6 reflector
5a, 5b,5c first to third THz transceiver
6a, 6b, 6c first to third reflector
8 THz measuring beam
9 reflected THz radiation
10 controller and evaluation unit
14 interior surface
15 exterior surface
A axis of symmetry
B, B1, B2, B3 optical axes
MP1, MP2, MP3 measuring position of the THz transceivers
RP1, RP2, RP3 reflector position of the reflectors
NA neighborhood region (supplement)
α offset angle of the optical axes B
P1, P2 first and second reflection peak, facing reflection peaks
P3, P4 third and fourth reflection peak, averted reflection peaks, later in time
S1a, S1b. S1c measuring signals
TP total reflection peak
w1a facing wall region
w2a averted wall region
wd1a facing wall thickness of the facing wall region W1a
wd2a averted wall thickness of the averted wall region W2a
AD exterior diameter
ID interior diameter

The following numbered clauses include embodiments that are contemplated and non-limiting:

Clause 1. THz measuring method for measuring a transported strand (3), in particular, an extruded pipe (3), in a measuring space (2) of a THz measuring device 1(1), including at least the following steps:
providing at least three THz measuring units (4) around the measuring space (2), the THz measuring units (4) each including a THz transceiver (5, 5a, 5b, 5c) with an optical axis (B) and a reflector (6; 6a, 6b, 6c) arranged in the optical axis (B) and situated opposite in the measuring space (2),
transporting the strand (3) through the measuring space (2),
for all THz measuring units (4, 4a, 4b, 4) each
emitting a THz measuring beams (8) from the THz transceiver (5) along its optical axis (B) and
detecting reflected THz radiation (9) which has been partially reflected from the wall region facing the THz transceiver (5), and detecting THz radiation (9) which has been reflected on the opposite reflector (6), and for at least a first THz measuring unit (4a)
determining a facing wall thickness (wd1a) of the first optical axis (B1) by means of a first measuring signal of the first transceiver (5a) and
determining an averted wall thickness (wd2a) of the wall region averted from the transceiver (5a) on the first optical axis (B1) by means of the measuring signals (S1b, S1c) of the THz transceivers (5b, 5c) of the adjacent THz measuring units (4b, 4c) that are adjacent in the circumferential direction to the first reflector (6a).

Clause 2. THz measuring method according to clause 1, wherein the averted wall thickness (wd2a) on the first optical axis (B1) is determined by means of an averaging, in particular, as arithmetic average, of the THz transceivers (5b, 5c) adjacent to the first reflector (6a).

Clause 3. THz measuring method according to clause 1 or 2, wherein the averted wall thickness (wd2a) on the first optical axis (B1) is determined without including partial reflections of the first measuring beam (8) on the boundary surfaces of the averted wall region.

Clause 4. THz measuring method according to one of the above clauses, wherein the THz transceivers (5) each emit parallel THz measuring beams (8), and the reflectors (6) are configured flat for reflecting the parallel THz measuring beams (8).

Clause 5. THz measuring method according to one of the above clauses, wherein the strand (3) is transported through the measuring space (2) without guidance by the THz measuring device (1) and without a guide means of the THz measuring device (1) and is contactless measured by the THz measuring device (1).

Clause 6. THz measuring method according to one of the above clauses, wherein the multiple measuring axes (B) define a measuring plane in the measuring space (2), and the optical axes (B1, B2, B3) of the multiple THz measuring units (4; 4a, 4b, 4c) intersect in a common axis of symmetry (A) of the measuring plane, and the strand (3) is transported through the measuring plane (E) and continuously measured in the measuring plane (E), where, preferably, the strand may also leave the axis of symmetry during transport through the measuring plane.

Clause 7. THz measuring method according to clause 6, wherein upon a change in the position of the strand (3) in the measuring plane, the THz measuring units (4) are adjusted or readjusted in the measuring plane, for contactless centering of the strand (3), in particular, in the axis of symmetry of the measuring plane, e.g., by means of a cross table for adjusting the THz measuring device (1) in the two directions of the measuring plane.

Clause 8. THz measuring method according to clause 6 or 7, wherein a misplacement of the strand (3) in relation to the axis of symmetry (A)
is determined from the measuring signals and/or an external sensor, and/or
is taken into account upon determining the facing and/or averted wall thickness (wd1a, wd2a).

Clause 9. THz measuring method according to one of the above clauses, wherein an at least single-layer strand (3) is measured, which exhibits an exterior boundary surface (15) and an interior boundary surface (14), in particular, following an extrusion of the strand (3), where the layer thickness is determined from a time of flight difference between the reflection peaks (P1, P2) of the measuring signal.

Clause 10. THz measuring method according to one of the above clauses, wherein prior to the object measurement and/or after the object measurement, a step of a calibration measurement with an empty measuring space (2) is carried out, in which with an empty measuring space (2) without the strand (3) at least the first THz transceiver (5; 5a, 5b, 5c), preferably alle THz transceivers of the THz measuring units (4; 4a, 4b, 4c), each emit their THz measuring beam (8) along their optical axis (B1, B2, B3) and detect the total reflection peak (TP) at their associated reflector (6; 6a, 6b, 6c), and, by taking the calibration measurement into account in the object measurement, the following is determined: the wall thicknesses (wd1a, wd2a, a refractive index (c3) of the material of the strand (3), preferably also an exterior diameter (AD) and/or an interior diameter (ID) of the strand (3).

Clause 11. THz measuring method according to one of the above clauses, wherein in the circumferential direction around the measuring space (2) more than three THz measuring units (4) are arranged, in particular, in an alternating manner, and for all THz measuring units (4) each the averted wall thickness (wd2) is determined by averaging the adjacent THz measuring units.

Clause 12. THz measuring method according to one of the above clauses, wherein the THz measuring units (4), arranged in the circumferential direction around the measuring space (2) and at least partially alternating, determine a wall thickness profile of the wall thickness and/or of the exterior diameter (AD) and/or of the interior diameter (ID) of the strand (3) in the circumferential direction.

Clause 13. THz measuring method according to one of the above clauses, wherein the THz measuring units (4), arranged in the circumferential direction around the measuring space (2) and at least partially alternating, determine a wall thickness profile of the wall thickness and/or of the exterior diameter (AD) and/or of the interior diameter (ID) of the strand (3) in the circumferential direction.

Clause 14. THz measuring method according to one of the above clauses, wherein for determining the averted wall thickness (wd2a), additionally, the next to adjacent facing wall thicknesses of the next to adjacent THz measuring units are used in addition to the facing wall thicknesses of the adjacent THz measuring units, for averaging across multiple THz measuring units (4).

Clause 15. THz measuring device (1) for measuring a strand (3), in particular, a pipe (3), the THz measuring device (1) comprising:
a measuring space (2) with an axis of symmetry (A), for receiving the strand (3),
at least three THz measuring units (4; 4a, 4b, 4c),
all THz measuring units (4; 4a, 4b, 4c) each including a THz transceiver (5; 5a, 5b, 5c) for emitting a THz measuring beams (8) along its optical axis (B; B1, B2, B3) and a reflector (6; 6a, 6b, 6c) arranged on the optical axis (B1, B2, B3) and opposite the THz transceiver (5; 5a, 5b, 5c),
a controller and evaluating unit (10) receiving the measuring signals (S1a, S1b, S1c) of the THz transceivers (5; 5a, 5b, 5c) and determining at least wall thicknesses (wd1a, wd2a) of the strand (3),
the THz measuring units (4) being arrange in an alternating manner such that a first reflector (6a) of a first THz measuring unit (4a) is adjacent to a second THz transceiver (5b) of a second THz measuring unit (4b) and a third THz transceiver (5c) of a third THz measuring unit (4c),
the controller and evaluating unit (10) being configured, in performing a measurement of the strand (3),
to determine a facing wall thickness (wd1a) of the facing wall region (w1a) from a first measuring signal (S1a) of the first transceiver (5a), and
to determine an averted wall thickness (wd2a) of the averted wall region (w2a) of the first transceiver (5a) by means of averaging and/or interpolation from measuring signals (S1b, S1c) of the second transceiver (5b) and the third transceiver (5c).

Clause 16. THz measuring device (1) according to clause 15, wherein it is configured without guide means for the strand (3), and the controller and evaluating unit (10) is configured for contactless measuring of the strand (3) transported through the measuring space (2).

Clause 17. THz measuring device (1) according to clause 16, wherein it comprises an adjustment means for translational, common adjustment of transceivers and reflectors in the measuring plane, for readapting to the position of the strand (2) without contacting the strand.

Clause 18. THz measuring device (1) according to one of the clauses 15 through 17, wherein the second and third THz transceivers (5b, 5c) are arranged with their optical axes (B2, B3) opposite the first optical axis (B1) in a symmetrical arrangement at equal offset angles (a).

Clause 19. THz measuring device (1) according to one of the clauses 15 through 18, wherein the optical axes (B2, B3) of the second and third THz transceivers (5b, 5c) have an offset angle (a) of less than 45°, in particular, less than 30°, e.g., less than 25° in relation to the first optical axis (B1).

Clause 20. THz measuring device (1) according to one of the clauses 15 through 19, wherein the controller and evaluating unit (10) is configured to determine, for all of the multiple THz measuring units (4) each, the averted wall thickness (wd2a, wd2b, wd2c) in their optical axes (B2, B3) by averaging of the adjacent THz transceivers (5).

Clause 21. THz measuring device (1) according to clause 20, wherein at least six THz measuring units (4), in particular, at least nine THz measuring units (4), e.g., at least 15 THz measuring units (4), are arranged in the circumferential direction around the measuring space (2), spaced apart and at least partially alternating in relation to one another, at equal offset angles (a) in relation to one another, and where the controller and evaluating unit (10) is configured to carry out a circumferential measuring of the strand (3), in which
on each optical axis (B) always the facing wall region is measured by the respective THz measuring unit (4) and the averted wall regions (w2a, w2b, w2c) by means of the adjacent THz transceivers (5).

Clause 22. THz measuring device (1) according to one of the clauses 15 through 21, wherein the THz measuring units (4) are arranged fixed or stationary around the measuring space (2).

Clause 23. THz measuring device (1) according to one of the clauses 15 through 22, wherein for determining the averted wall thickness (wd2a) the measurements of the facing wall thicknesses of the THz transceivers next following to the adjacent THz transceivers (5b, 5c) in the circumferential direction are used additionally, for generating a wall thickness profile for determining the averted wall thickness (wd2a).

Clause 24. THz measuring device (1) according to one of the clauses 15 through 23, wherein
the THz transceiver (5) is configured such that it emits the THz measuring beam (8) in a parallel manner and the reflector (6) is configured flat so as to reflect the parallel THz measuring beam (8).

Clause 25. THz measuring method or THz measuring device according to one of the above clauses, wherein the THz measuring beam (8) lies in a frequency range of terahertz, radar or microwave radiation, in particular, between 5 GHz and 50 THz, in particular, between 10 GHZ and 10 THZ, in particular, 20 GHz and 3 THZ, in particular, as a time-of-flight measurement, frequency modulation, e.g., FMCW radar, and/or pulsed radiation.

1. A THz measuring method for measuring a transported strand in a measuring space of a THz measuring device, including at least the following steps:
providing at least three THz measuring units around the measuring space, the THz measuring units each including a THz transceiver with an optical axis and a reflector arranged in the optical axis and situated opposite in the measuring space,
transporting the strand through the measuring space,
for all THz measuring units each
emitting a THz measuring beams from the THz transceiver along its optical axis and
detecting reflected THz radiation which has been partially reflected from the wall region facing the THz transceiver, and detecting THz radiation which has been reflected on the opposite reflector,
and for at least a first THz measuring unit
determining a facing wall thickness of the first optical axis by means of a first measuring signal of the first transceiver and
determining an averted wall thickness of the wall region averted from the transceiver on the first optical axis by means of the measuring signals of the THz transceivers of the adjacent THz measuring units that are adjacent in the circumferential direction to the first reflector.

2. The THz measuring method of claim 1, wherein the averted wall thickness on the first optical axis is determined by means of an averaging of the THz transceivers adjacent to the first reflector.

3. The THz measuring method of claim 1, wherein the averted wall thickness on the first optical axis is determined without including partial reflections of the first measuring beam on the boundary surfaces of the averted wall region.

4. The THz measuring method of claim 1, wherein the THz transceivers each emit parallel THz measuring beams, and the reflectors are configured flat for reflecting the parallel THz measuring beams.

5. The THz measuring method of claim 1, wherein the strand is transported through the measuring space without guidance by the THz measuring device and without a guide means of the THz measuring device and is contactless measured by the THz measuring device.

6. The THz measuring method of claim 1, wherein the multiple measuring axes define a measuring plane in the measuring space, and the optical axes of the multiple THz measuring units intersect in a common axis of symmetry of the measuring plane, and the strand is transported through the measuring plane and continuously measured in the measuring plane.

7. The THz measuring method of claim 6, wherein upon a change in the position of the strand in the measuring plane, the THz measuring units are adjusted or readjusted in the measuring plane, for contactless centering of the strand.

8. The THz measuring method of claim 6, wherein a misplacement of the strand in relation to the axis of symmetry
is determined from the measuring signals and/or an external sensor, and/or
is taken into account upon determining the facing and/or averted wall thickness.

9. The THz measuring method of claim 1, wherein an at least single-layer strand is measured, which exhibits an exterior boundary surface and an interior boundary surface, where the layer thickness is determined from a time of flight difference between the reflection peaks of the measuring signal.

10. The THz measuring method of claim 1, wherein prior to the object measurement and/or after the object measurement, a step of a calibration measurement with an empty measuring space is carried out, in which with an empty measuring space without the strand at least the first THz transceiver, and detects the total reflection peak at its associated reflector, and, by taking the calibration measurement into account in the object measurement, the following characteristics are determined:
the wall thicknesses and a refractive index of the material of the strand.

11. The THz measuring method of claim 1, wherein in the circumferential direction around the measuring space more than three THz measuring units are arranged, and for all THz measuring units each the averted wall thickness is determined by averaging the adjacent THz measuring units.

12. The THz measuring method of claim 1, wherein the THz transceivers of the multiple THz measuring units emit their THz measuring beam in an alternating manner, and the respective passive THz transceivers detect scatter radiation on the strand, for subsequent determination of faults or irregularities of the strand.

13. The THz measuring method of claim 1, wherein the THz measuring units, arranged in the circumferential direction around the measuring space and at least partially alternating, determine a wall thickness profile of the wall thickness and/or of the exterior diameter and/or of the interior diameter of the strand in the circumferential direction.

14. The THz measuring method of claim 1, wherein for determining the averted wall thickness, additionally, the next to adjacent facing wall thicknesses of the next to adjacent THz measuring units are used in addition to the facing wall thicknesses of the adjacent THz measuring units, for averaging across multiple THz measuring units.

15. A THz measuring device for measuring a strand, the THz measuring device comprising:
a measuring space with an axis of symmetry, for receiving the strand,
at least three THz measuring units,
all THz measuring units each including a THz transceiver for emitting a THz measuring beams along its optical axis and a reflector arranged on the optical axis and opposite the THz transceiver,
a controller and evaluating unit receiving the measuring signals of the THz transceivers and determining at least wall thicknesses of the strand,
the THz measuring units being arrange in an alternating manner such that a first reflector of a first THz measuring unit is adjacent to a second THz transceiver of a second THz measuring unit and a third THz transceiver of a third THz measuring unit, the controller and evaluating unit being configured, in performing a measurement of the strand,
to determine a facing wall thickness of the facing wall region from a first measuring signal of the first transceiver, and
to determine an averted wall thickness of the averted wall region of the first transceiver by means of averaging and/or interpolation from measuring signals of the second transceiver and the third transceiver.

16. The THz measuring device of claim 15, wherein it is configured without guide means for the strand, and the controller and evaluating unit is configured for contactless measuring of the strand transported through the measuring space.

17. The THz measuring device of claim 16, wherein it comprises an adjustment means for translational, common adjustment of transceivers and reflectors in the measuring plane, for readapting to the position of the strand without contacting the strand.

18. The THz measuring device of claim 15, wherein the second and third THz transceivers are arranged with their optical axes opposite the first optical axis in a symmetrical arrangement at equal offset angles.

19. The THz measuring device of claim 15, wherein the optical axes of the second and third THz transceivers have an offset angle of less than 45°, in particular, less than 30°, e.g., less than 25° in relation to the first optical axis.

20. The THz measuring device of claim 15, wherein the controller and evaluating unit is configured to determine, for all of the multiple THz measuring units each, the averted wall thickness in their optical axes by averaging of the adjacent THz transceivers.

21. The THz measuring device of claim 20, wherein at least six THz measuring units, in particular, at least nine THz measuring units, e.g., at least 15 THz measuring units, are arranged in the circumferential direction around the measuring space, spaced apart and at least partially alternating in relation to one another, at equal offset angles in relation to one another, and where the controller and evaluating unit is configured to carry out a circumferential measuring of the strand, in which
on each optical axis always the facing wall region is measured by the respective THz measuring unit and the averted wall regions by means of the adjacent THz transceivers.

22. The THz measuring device of claim 15, wherein the THz measuring units are arranged fixed or stationary around the measuring space.

23. The THz measuring device of claim 15, wherein for determining the averted wall thickness the measurements of the facing wall thicknesses of the THz transceivers next following to the adjacent THz transceivers in the circumferential direction are used additionally, for generating a wall thickness profile for determining the averted wall thickness.

24. The THz measuring device of claim 15, wherein the THz transceiver is configured such that it emits the THz measuring beam in a parallel manner and the reflector is configured flat so as to reflect the parallel THz measuring beam.

25. The THz measuring device of claim 15, wherein the THz measuring beam lies in a frequency range of terahertz, radar or microwave radiation, in particular, between 5 GHz and 50 THz, in particular, between 10 GHZ and 10 THZ, in particular, 20 GHz and 3 THZ, in particular, as a time-of-flight measurement, frequency modulation, e.g., FMCW radar, and/or pulsed radiation.
